(19) United States
(12) Patent Application Publication
(10) Pub. No.: US 2019/0129974 A1
(43) Pub. Date: May 2, 2019

(54) FOLDER-BASED FILE MANAGEMENT DEVICE AND METHOD

(71) Applicants: Jae Ho CHOI, Seoul (KR); DELTA PDS CO., LTD., Seoul (KR)

(72) Inventor: Jae Ho CHOI, Seoul (KR)

(73) Assignees: DELTA PDS., LTD., Seoul (KR); Jae Ho CHOI, Seoul (KR)

(21) Appl. No.: 16/176,166

(22) Filed: Oct. 31, 2018

(30) Foreign Application Priority Data
Oct. 31, 2017 (KR) 10-2017-0143278
Jan. 8, 2018 (KR) 10-2018-0002417
Jan. 15, 2018 (KR) 10-2018-0005033
Oct. 18, 2018 (KR) 10-2018-0124610

(51) Int. Cl. G06F 17/30; H04L 29/06

(52) U.S. Cl. CPC G06F 17/30165; H04L 65/403; G06F 17/30144; G06F 17/30126

(57) ABSTRACT

A folder-based file management device includes: a memory and a processor electrically connected to the memory, the processor being configured to: sense a user terminal's access to a folder; provide a list of files in the folder the user terminal is given access to; and provide file badges for the files to which the user terminal is given access. The file badges indicate the number of file updates not read by the user terminal that are made when a file the user terminal is given access to is uploaded or updated.

### CROSS-REFERENCE TO PRIOR APPLICATIONS

This application claims priority to Korean Patent Application Nos. 10-2017-0143278 (filed on Oct. 31, 2017), 10-2018-0002417 (filed on Jan. 8, 2018), 10-2018-0005033 (filed on Jan. 15, 2018), and 10-2018-0124610 (filed on Oct. 18, 2018), which are all hereby incorporated by reference in their entirety.

### BACKGROUND

### Field of the Invention

The present invention relates to a file management technique, and more particularly, to a folder-based file management device and method that improve user convenience because the system and method let the user intuitively know about file updates by other users by managing files in a shared folder using the concept of a file badge per user per file.

### Related Art

A file-sharing program may be implemented by applications that store and manage users' files in user accounts on a server, and may provide a function for uploading or downloading a file requested by the user. With the increasing number of users who use file-sharing programs, a variety of file-sharing applications are being developed to render a file sharing process between various users efficient.

### SUMMARY

The present invention provides a folder-based file management device and method that improve user convenience because the system and method let the user intuitively know about file updates by other users by managing a shared folder and files in the shared folder using the concept of a file badge per user per file and a folder badge per user per folder.

An exemplary embodiment of the present invention provides a folder-based file management device comprises a memory and a processor electrically connected to the memory, the processor being configured to: (a) sense a user terminal's access to a folder; (b) provide a list of files in the folder the user terminal is given access to; and (c) provide file badges for the files the user terminal is given access to, wherein the file badges indicate the number of file updates not read by the user terminal that are made when a file the user terminal is given access to is uploaded or updated

An exemplary embodiment of the present invention provides a folder-based file management method which is performed by a folder-based file management device comprising a memory and a processor electrically connected to the memory, the method comprising: (a) sensing a user terminal's access to a folder; (b) providing a list of files in the folder the user terminal is given access to; and (c) providing file badges for the files the user terminal is given access to, wherein the file badges indicate the number of file updates not read by the user terminal that are made when a file the user terminal is given access to is uploaded or updated.

### BRIEF DESCRIPTION OF THE DRAWINGS

FIG. 1 is a view illustrating a folder-based file management system according to an exemplary embodiment of the present invention.

FIG. 2 is a block diagram showing the folder-based file management device in FIG. 1.

FIG. 3 is a block diagram showing functional elements of the processor shown in FIG. 2.

FIG. 4 is a view showing an exemplary embodiment of a process in which the file badge manager in FIG. 3 manages file updates in a sequential list that is chronologically vectorized.

FIG. 5 is a view showing an exemplary embodiment of a process in which the processor manages modified files in a sequential list that is chronologically vectorized.

FIG. 6 is a flowchart showing a folder-based file management method according to an exemplary embodiment of the present invention.

FIG. 7 is a view showing an exemplary embodiment of a process in which a user terminal in FIG. 1 provides a shared folder interface by working in conjunction with a folder-based file management device.

FIG. 8 is a view showing another exemplary embodiment of a process in which a user terminal provides a user interface by working in conjunction with a folder-based file management device.

FIG. 9 is a view showing yet another exemplary embodiment of a process in which a user terminal provides a user interface by working in conjunction with a folder-based file management device.

### DETAILED DESCRIPTION

Explanation of the present invention is merely embodiments for structural or functional description, so the scope of the present invention should not be construed to be limited to the embodiments explained in the embodiment. That is, since the embodiments may be implemented in several forms, it should also be understood that the scope of the present invention includes equivalents able to realize its technical idea. In addition, it does not mean that a specific embodiment embraces all the purposes or effects suggested in the present invention or embraces only such effects, and therefore, it should be understood that the scope of the present invention is not limited thereto.

Meanwhile, terms used in the following description need to be understood as below.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to” and the like, should be similarly interpreted.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, numerals, operations, components, parts, or a combination thereof, but do not preclude the presence or addition of one or more other features, numerals, steps, operations, components, parts, or a combination thereof.

Indication references of steps (i.e., a, b, and c) are used for convenience of explanation and do not indicate a sequence of the steps. Unless explicitly defined as a specific sequence in the context, the indication references may be performed in a different order. That is, each step can be substantially performed at the same time or can be performed in reverse order in accordance with a function corresponding to the block.

The present invention as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a read only memory (ROM), a random access memory (RAM), a compact disk read only memory (CD-ROM), a magnetic tape, a floppy disc, and an optical data storage device. In addition, the computer-readable recording medium may be distributed in a computer system connected by a network, and store and implement a computer-readable code in a distributed manner.

Unless indicated otherwise, it is to be understood that all the terms used in the specification including technical and scientific terms have the same meaning as those that are understood by those who skilled in the art. It must be understood that the terms defined by the dictionary are identical with the meanings within the context of the related art, and they should not be ideally or excessively formally defined unless the context clearly dictates otherwise.

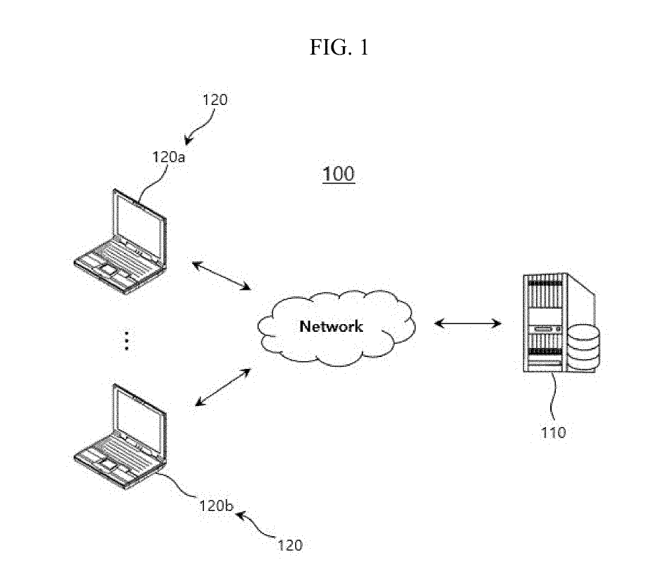

FIG. 1 is a view illustrating a folder-based file management system according to an exemplary embodiment of the present invention.

Referring to FIG. 1, the folder-based file management system 100 includes a folder-based file management device 110 and a user terminal 120.

The folder-based file management device 110 corresponds to a computing device that may be connected via a network to at least one user terminal 120. In an exemplary embodiment, the folder-based file management device 110 may manage at least one group including a user associated with the user terminal 120 as a member. In an exemplary embodiment, the folder-based file management device 110 may be connected to the user terminal 120 through a shared folder agent installed on the user terminal 120. Wherein, the shared folder agent corresponds to an agent program which is software that, once installed on the user terminal 120, helps the user terminal 120 and the folder-based file management device 110 work together with the approval of the user terminal 120.

The user terminal 120 corresponds to a computing device that can be connected via a network to the folder-based file management device 110—for example, a user terminal implemented as a desktop, laptop, tablet pc, or smartphone.

In an exemplary embodiment, a first user terminal 120a may correspond to a mobile terminal, and may be connected to the folder-based file management device 110 through cellular communication or WiFi communication. In another exemplary embodiment, a second user terminal 120b may correspond to a desktop, and may be connected to the folder-based file management device 110 through the internet.

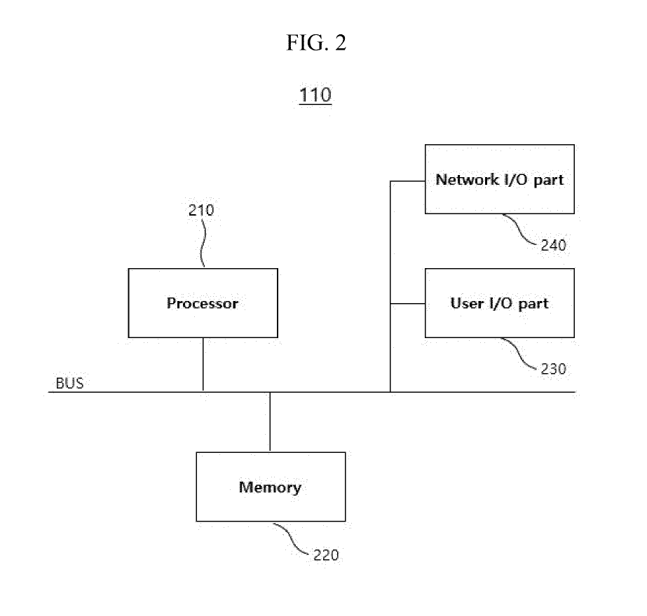

FIG. 2 is a block diagram showing the folder-based file management device in FIG. 1.

Referring to FIG. 2, the folder-based file management device 110 may include a processor 210, a memory 220, a user input/output part 230, and a network input/output part 240.

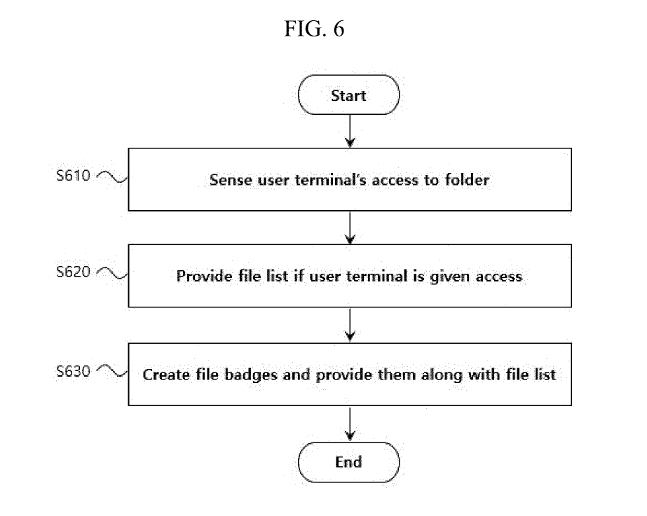

The processor 210 may execute a shared folder file management procedure in FIG. 6, manage the memory 220 which is read or written in this procedure, and schedule synchronization between volatile and non-volatile memories in the memory 220. The processor 210 may control the overall operation of the folder-based file management device 110, and may be electrically connected to the memory 220, user input/output part 230, and network input/output part 240 and control data follow between them. The processor 210 may be implemented as a CPU (Central Processing Unit) of the folder-based file management device 110.

The memory 220 may include auxiliary storage which is implemented as a non-volatile memory such as SSD (Solid State Disk) or HDD (Hard Disk Drive) and used to store overall data required for the folder-based file management device 110 or primary storage which is implemented as a volatile-memory such as RAM (Random Access Memory). That is to say, the memory 220 may be implemented as a volatile or non-volatile memory, and may be connected by a hyperlink if implemented as a non-volatile memory.

The user input/output part 230 includes an environment for receiving user input and an environment for outputting particular information to the user—for example, an input device including an adapter such as a mouse, trackball, touchpad, graphic tablet, scanner, touchscreen, keyboard, or pointing device, or an output device including an adaptor such as a monitor or touchscreen. In an exemplary embodiment, the user input/output part 230 may correspond to a computing device connected via a remote connection, in which case the folder-based file management device 110 may serve as a server.

The network input/output part 240 may include an environment for connecting to the user terminal 120 via a network—for example, an adapter for LAN (Local Area Network) communication.

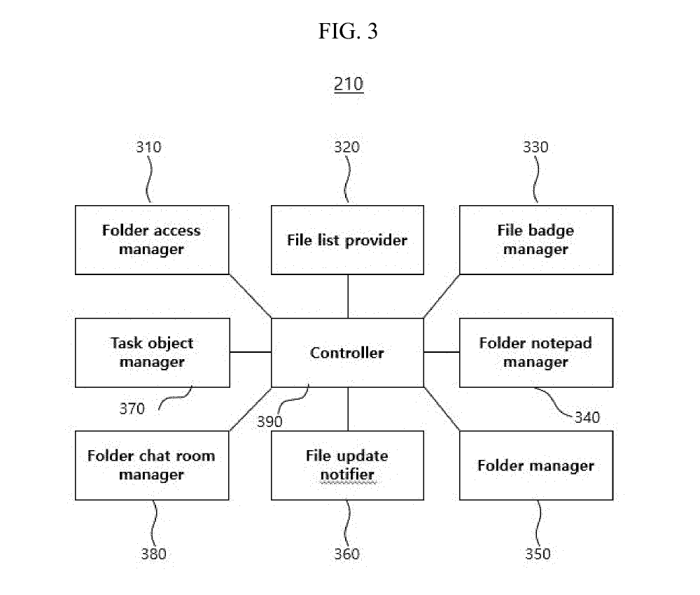

FIG. 3 is a block diagram showing functional elements of the processor shown in FIG. 2.

Referring to FIG. 3, the processor 210 may include a folder access manager 310, a file list provider 320, a file badge manager 330, a folder notepad manager 340, a folder manager 350, a file update notifier 360, a task object manager 370, a chat room manager 380, and a controller 390.

It should be noted that the processor according to the exemplary embodiment of the present invention does not always include all of the above components, some of the above components may be omitted in some embodiments, and some or all of the above components may be selectively included.

When the user terminal 120 accesses or attempts to access a folder, the folder access manager 310 receives the access from the user terminal 120. More specifically, the folder access manager 310 may receive an access request for a specific folder from the user terminal 120, and may verify the user's access and determine whether to give the user access or not.

Wherein, the folder access manager 310 may acquire user information associated with the user terminal 120 or identification information of the user terminal and verify the user terminal 120's access to the folder. The folder access manager 310 may only give access when it is verified that the user or the user terminal has access to the folder. In an exemplary embodiment, whether the user or the user terminal has access to the folder may be determined depending on whether the user has an invitation the folder creator n sent when the folder creator creates the folder. That is, only users who the folder creator invited to the folder have access to the folder.

The folder access manager 310 may add, modify, or delete files or sub-folders to the folder upon a request from a folder user. Wherein, the files may include general user files such as document files or multimedia files sent from the user terminal 120.

The file list provider 320 may provide a list of files in the folder and file badges for each user for each file. The file list provider 320 provides a list of files in the folder.

Wherein, the files may include all types of objects, including documents, still images, videos, tables, and voice data that are stored in the folder or can be accessed through the folder. Also, the files may include folder notes, which are notes associated with the folder, task objects that are stored in the folder, can be accessed through the folder, and are associated with files in the folder, and the files with which the task objects are associated. Notably, a file badge for a folder note may be called a file badge or a folder note badge. As for a file with which a task object is associated, any updates to the task object may be reflected on the file badge of the associated file.

Accordingly, in one exemplary embodiment, the file list provider 320 may provide the user terminal 120 with the user's folder note badges for one or more folder notepads associated with the folder and the user's file badges for the files in the folder in the process of providing a file list, and may allow the user terminal 120 visualize this.

Also, in one exemplary embodiment, if the user terminal 120 is given access to the folder through the folder access manager 310, the file list provider 320 may provide the user terminal 120 metadata about the files and sub-folders in the folder and a file list including access paths to the files and sub-folders.

More specifically, if the user terminal 120 is given access to the folder through the folder access manager 310, the file list provider 320 may provide the user terminal 120 with i) a file list containing metadata about the files and sub-folders in the folder and ii) file badges for each user for each file that contain information on modifications made by each folder user participating in the folder to at least one file in the folder.

A file badge represents the cumulative number of updates to a specific file, including all events such as uploading and/or modifying, adding, changing, and updating that file. By the way, a file badge according to an exemplary embodiment of the present invention does not simply represent the cumulative number of updates caused by the above events, but the cumulative number of updates a specific user has not checked. That is, a file badge according to an exemplary embodiment may represent the number of updates a specific user has not checked, among file updates including uploading, modifying, and changing a specific file for that user.

Therefore, file badges are stored differently for each file, and counted, stored, and visualized on a per-user basis, because, if a plurality of users participate in sharing a folder, which files are read or not and updates to the files depend on each user. A file badge may be an index that quantifies and shows items a single specific user needs to read and check later on a specific file.

For example, assuming that File 1 and File 2 are in a folder and User A and User B are users of this folder, a file badge per user per file may contain information on modifications and updates to File 1 or File 2 and information about whether User A or User B read File 1 or File 2.

That is, when File 1 is uploaded as a file accessible by User A, the file badge of File 1 has a value of 1. Then, when User A accesses the uploaded File 1 and reads out it, the file badge has a value of 0. Afterwards, if n file updates are made as User B or User C who has access updates File 1, such as modifying or changing the file or adding a note to it, the file badge of File 1 shown to User A has a value of n until User A checks the file updates. Then, when User A checks all of the n file updates by opening and reading File 1, the file badge of File 1 shown to User A has a value of 0 again.

The file badge manager 330 may detect a file modification made by a certain user terminal 120 and update the user's own per-file file modification history. Wherein, each per-user, per-file file modification history contains modifications made by each user to each file. For example, if user Hong Gil-dong modifies File 1 in the folder, this affects all the folder users participating in the folder and therefore the per-file file modification histories are updated on a per-user basis.

In the process of updating a per-file file modification history, the file badge manager 330 may log, in the per-file file modification history, the dates when file modifications are made during a specific period in the past from the present or the dates during which a specific number of file modifications are made. For example, the file badge manager 330 may sequentially log a number of file modification dates a, b, c, and d for File 1 in the file modification history, or may reflect file modifications made for 1 year or three months in the past from the present or reflect up to 100 file modifications.

In an exemplary embodiment, the file badge manager 330 may determine the specific number based on the following Equation 1 in the above process, and log the dates during which the determined, specific number of file modifications are made in the per file file modification history. For example, assuming that magi and mav2 are detected as 2.6 and 1.4, respectively, and no is set to 50, the file badge manager 330 may calculate n to be 93 according to the following Equation 1 and determine the calculated n as the specific number which allows for logging file modification dates.

$$n = ⌈ {n}_{0} \frac{{m}_{av 1}}{{m}_{av 2}} ⌉ \qquad [ Equation 1 ]$$

wherein mₐᵥ₁ represents the average daily number of modifications made to all the files in the folder over a first specific period (e.g., last week), and mₐᵥ₁ represents the average daily number of modifications made to all the files in the folder over a second specific period (e.g., last three months). Wherein, the second specific period is a period of time longer than the first specific period. Wherein, n₀ represents a reference cumulative number (e.g., 100) and may be set by the user or designer, and ┌ ┐ refers to an operation of rounding an internal value to an integer.

When a file modification is detected in the process of updating the per-file file modification history, the file badge manager 330 may reflect user information of the user terminal 120, along with the file modification date, in the per-file file modification history. For example, each time a file modification is made to File 1, the file badge manager 330 may log the file modification date and the user who has made the modification in the per-file file modification history.

In the process of providing file badges for each user for each file, the file badge manager 330 may create a file badge per file for the user, based on the user's file access time associated with the user information and the per-file file modification history.

For example, the file badge manager 330 may check the file modification dates 2017.10.21 12:08:51, 2017.10.24 10:32:08, and 2017.10.25 18:13:07 of File 1 from the file modification histories of File 1 and File 2 in Folder 1 to which User A has access. If the date and time User A last accessed File 1 are 2017.10.22 13:35:05, the file badge manager 330 may count the file modifications made on 2017.10.24 10:32:08 and 2017.10.25 18:13:07 and calculate the file badge for File 1 for User A to be 2.

That is, the number of unchecked modifications, which is the total number of modifications made to a specific file minus the number of modifications checked or read by a specific user, is counted, and the count is the value of the file badge for that file presented to that user. To this end, according to an exemplary embodiment of the present invention, the cumulative number of modifications made after the time the user last accessed the file may be reflected as the value of the file badge by comparing the file modification times with the time the user last accessed the file.

In the process of providing the user terminal 120 with file badges for each user for each file and allowing the user terminal 120 to show a file list for a corresponding folder, the file badge manager 330 may visualize file badges for each of at least one file in that folder.

The file badge manager 330 detects that a file is read by the user terminal 120 and updates the badge for that file for that user. In an exemplary embodiment, the file badge manager 330 may detect the user's access to a specific file and update the file access time and the file badge for the file for the user.

For example, if the user terminal 120 of the user “Choi Jae-Ho” opens or downloads “A solution for filter quality control” which is in the corresponding file list and whose file badge number is [3], the file badge manager 330 may update the file badge for that file for this user from [3] to [0].

The file badge manager 330 may accumulate a user's file badges for a folder and its sub-folders and reflect them on the cumulative count of file badges for the corresponding folder, based on the corresponding user's file access times and file modification history for each file. For example, as stated above, the file badge manager 330 may create file badges for each file based on the user “Choi Jae-Ho”s file access times and file modification history for each file.

In an exemplary embodiment, if a folder notepad is provided, the file badge manager 330 may manage file badges for general files and file badges for the folder notepad separately. The file badge manager 330 may provide the user terminal 120 with file badges for each user for each file, which are managed separately from the file badges for the folder notepad, so that the user terminal 120 displays these different types of file badges separately.

For example, based on file badges each user is awarded for each file, the user terminal 120 may show the number of updates to general files by displaying file badges for the corresponding user for the corresponding files through the file list's first file badge cumulative count symbols, and may show the number of updates to a folder notepad by displaying file badges for the folder notepad the corresponding user has access through the file list's second file badge cumulative count symbols.

Wherein, the processor 210 may further include an associated file modification history manager (not shown). When an associated link to a specific file is created in a folder notepad, the associated file modification history manager may detect modifications made to that file by a certain user terminal 120 from that point onwards and update the user's file modification history for the specific file.

For example, if an associated link to File 1 is created in Folder Notepad 1, the associated file modification history manager may create a per-user file modification history for File 1 and add the date and time of modification, the user who made the modification, and the modified content to the corresponding file modification history each time a modification to the file is detected.

In an exemplary embodiment, the associated file modification history manager may keep track of modified content by copying pre-modified and modified files to a file modification tracking container of the corresponding file modification history.

In an exemplary embodiment, the associated file modification history manager may include an associated link for accessing the original of a specific file into a folder notepad at a point in time when an associated link is created, and may detect modifications to the specific file based on the original of the specific file and reflect them in the corresponding file modification history. In this case, the specific file associated with and linked to the folder notepad is in the corresponding folder, and corresponds to the original file whose latest modifications made until the present time are reflected.

In another exemplary embodiment, the associated file modification history manager may include a copy of a specific file into the folder notepad at a point in time when an associated link is created, and may detect modifications to the specific file based on the copy of the specific file and reflect them in the corresponding file modification history. In this case, the specific file associated with and linked to the folder notepad corresponds to a file copied at an associated point in time and latest modifications to the original file are not reflected after the associated point in time.

The associated file modification history manager may create file badges for each user indicating the number of updates not checked by each user, based on each user's own file modification history for a specific file associated with a folder notepad. In an exemplary embodiment, the associated file modification history manager may manage time stamps for the specific file through the per-user file modification history for the specific file, and may detect a user's access to the specific file and update the user's last access date and time and the file badge for the user in the corresponding file modification history.

The associated file modification history manager may immediately update time stamps for each user in the file modification history and file badges for each user derived from the time stamps whenever each folder user's access or modification to a specific file is detected in real time, and may accumulate a user's file badges for associated files in a folder and its sub-folders and reflect them on the cumulative count of file badges for the associated files in the corresponding folder.

The associated file modification history manager may detect user information with a file badge exceeding a reference value, based on the user's own file modification history for a specific file associated with a folder notepad, and suggest to the user terminal 120 associated with the corresponding user to read the specific file.

In an exemplary embodiment of the present invention, upon detecting a file badge exceeding a preset reference value (e.g., 10) in the process of updating the file modification history, the associated file modification history manager may retrieve the names or IDs of other users who modified the specific file after the user's last access date and provide a read suggestion message to the user terminal 120 of the corresponding user to suggest to read the specific file, along with the corresponding file badge and an access path for accessing the corresponding file.

The folder notepad manager 340 may provide a folder notepad in the process of providing a file list and file badges for each user for each file. Wherein, the folder note pad is a notepad associated with a folder, and support the functions of recording and sharing information related to the folder. The folder note pad is shared between at least one folder user, may include an associated link to a specific file in the folder, and allow for keeping track of modifications to the corresponding notes.

In an exemplary embodiment of the present invention, the folder notepad is also a type of file, which may be included in the file list or displayed separately from the file list. Also, since the folder notepad is also a type of folder, information on modifications or updates to the folder notepad may be provided to the user terminal 120 through the file badges for the folder notepad. It should be noted that the file badges for the folder notepad may be also called folder note badges for better explanation and understanding.

Moreover, the folder notepad manager 340 may verify the user terminal 120's access to a folder notepad associated with the folder and provide the folder notepad. More specifically, the folder notepad manager 340 may provide a folder notepad that can be created, modified, or deleted by at least one folder user having access to the folder and can keep track of modifications to the content contained in the folder notes.

The folder notepad manager 340 may create a folder notepad when a folder is created by a folder creator, and may determine at least one participator in the folder notepad by specifying users by the folder creator. Wherein, each of the at least one participator in the shared folder notepad may correspond to a user of the folder.

In an exemplary embodiment, the folder notepad manager 340 may selectively authorize each of the at least one participator in the folder notepad to read the folder notepad (e.g., read only) or modify it (e.g., read/write), based on user specification information about users who are authorized to read or modify.

The folder notepad manager 340 may select folder notepads the user is given access to by verifying the user terminal 120's access, and may provide the user terminal 120 with information about the selected folder notepads and a list of folder notepads including access paths to the folder notepads.

Update events for a folder notepad associated with a file may be reflected on the file badge value of the associated file. If a folder notepad is created in association with a specific file, the folder notepad manager 340 may reflect the created folder notepad in the file modification history for the file and update the file badge for the file.

The folder notepad manager 340, along with the file badge manager 330, may manage folder notes, updates to the folder notes, and details of the folder notes in sequential lists that are chronologically vectorized.

Each time an update to a folder notepad, such as a modification, change, etc., is detected, the folder notepad manager 340 may manage user information of a user who made the modification along with the corresponding modification date, and may provide user information of a user who modified a note as well in the process of providing tracked note content so that the user terminal 120 displays the note's content modified by different users in different colors, fonts, or sizes.

In another exemplary embodiment, the folder notepad manager 340 may store and manage pre-modified and modified files if a modification to a folder notepad is made by a certain user terminal 120, and may manage files modified during a specific period in the past form the present or a specific number of files.

Upon sensing or detecting that the user terminal 120 has read a folder notepad and updates, the folder notepad manager 340 may search for modified files which are created after the date and time the user last accessed the folder notepad, and may keep track of the modified note content by comparing the content of the modified file with the content of the file before the modification.

Also, the folder notepad manager 340 may keep track of modifications to folder notes contained in a folder notepad according to the following exemplary embodiments.

According to an exemplary embodiment, the folder notepad manager 340 may keep track of modifications to folder notes by managing the folder notes in a sequential list that is chronologically vectorized.

The folder notepad manager 340 may provide the user terminal 120 with file badges for the corresponding user for each folder notepad so that the user terminal 120 shows file badges, that is, folder note badges, for each of at least one folder notepad in the corresponding folder in the process of showing a file list for the corresponding folder.

The folder notepad manager 340 may detect the corresponding user's access to a folder notepad and update the user's last access date and time and the corresponding user's folder note badges in the corresponding folder note modification history. Whenever access or modification to each folder notepad for each participator in the notepad is detected in real time, the folder notepad manager 340 may immediately update time stamps for each user in the file note modification history and file badges for each user derived from the time stamps.

The folder notepad manager 340 may accumulate a user's folder note badges for a folder and its sub-folders and reflect them on the cumulative count of folder note badges. In an exemplary embodiment, the values of a user's folder note badges in all folder notepads associated with a folder or its sub-folders may be added to provide the sum as the cumulative count of folder note badges indicating the total number of updates to the entire folder the user has not checked.

The folder manager 350 may create and manage folders. More specifically, the folder manager 350 may create and manage at least one of files and sub-folders in a folder based on a user's request. Wherein, the files include general user files such as document files or multimedia files transmitted from the user terminal 120.

In an exemplary embodiment, upon receiving a folder creation request from the user terminal 120, the folder manager 350 may create a specific folder which a user associated with the user terminal 120 designated as a folder creator, and may determine at least one folder participator in that folder by inviting sharers by the folder creator. In an exemplary embodiment, when a folder is created by a folder creator, the folder manager 350 may give the folder creator access to the folder, including authority to delete the folder, and each folder participator may be given the folder sharers' authority to access, but without authority to delete the folder.

When a new update is made to a file in the folder by modifying or changing the file by a certain user terminal 120, the file update notifier 360 may notify the user terminals 120 respectively corresponding to at least folder user that the file is updated.

More specifically, a file in the folder may be modified by one of the folder users who have access to the folder notepad. In this case, the file update notifier 360 may immediately provide a notification message notifying that a new update is made to a file in the folder, apart from calculating the file badge values and updating the file badges by the file badge manager 330. Wherein, the notification message may be sent to the user terminals 120 respectively corresponding to the folder participators except the user who modified the file.

In an exemplary embodiment, if a specific file is modified by a certain user terminal 120, the file update notifier 360 may notify user terminals 120 associated with at least one folder user of the update to the file. Likewise, if a specific file in a specific folder is modified by one of the folder users who have access to that folder, the file update notifier 360 may immediately provide a notification message about the update to the file to user terminals 120 associated with the folder participators except the user who modified the file.

The task object manager 370 may include a task assigner, task assignment details, and task assignee from a certain user terminal 120, and may add a task object by receiving a task about which the task assignee may give feedback.

More specifically, the task object manager 370 may receive, from a user terminal 120 corresponding to a task assigner, a task including information about at least one of the following: task assignment details drawn up by the task assigner, a task assignee, a task evaluation, and a deadline. Moreover, the task object manager 370 may create a task object, which is a capsulized object, including information about at least one of the following: a task assigner, a task assignee, task assignment details, task processing details, a task evaluation, and a deadline, and may associate the task object with a folder, file, or folder notepad.

Information required for creating a task object may be received through a chat room, folder notepad, etc., in which case, therefore, the task object may be created through a chat room or folder notepad.

The task object manager 370 may allow for direct access to the task object from one or more users who participate in a corresponding task or a corresponding folder or a folder notepad or share a folder and files in the folder. Moreover, the task object may be stored in the folder as a separate task object message, which is distinct from a text message or multimedia message, or may be associated with a folder or a file in the folder. Further, the task object may be added to or associated with a folder notepad or work chat room.

Wherein, the task assignee is a user who is assigned by the corresponding task assigner to perform the task, and may be either a folder sharer or folder participator. The task evaluation may include a reserved rating, which indicates the highest rating limit that can be given by the task assigner, and an actual rating. Accordingly, the task assigner may easily assign a task to the task assignee through a folder and get information how the task is progressing from the task assignee.

In some embodiments, if a task object is created through a folder notepad or work chat room, the task assigner may share the task object through the folder notepad or task chat room which is shared between the participators in the folder notepad or task chat room. Then, the task assigner may easily assign a task, receive a task progress report, and evaluate the task by sending the task object to the task assignee in the folder notepad or task chat room.

The task object manager 370 may keep up with the progress of the task object, including a task progress status indicating how the task is progressing by stages, and may update the task object by keeping up with the progress based on feedback from the task assignee. In an exemplary embodiment, the task object manager 370 may update the task object in the folder notepad by updating a predetermined task progress status on a task progress diagram which defines how the task is progressing by stages, based on a request from either the task assigner or task assignee and a response from the other.

For example, the task progress status may include “New” which indicates that a new task object is created, “Doing” which indicates that the task assignee is working on the task object, “Done” which indicates that the task assignee has completed the task object and waits for an interaction with the task assigner about the completion of the task, and “Checked” which indicates that the task assigner has checked the task object completed by the task assignee.

The task object manager 370 may keep track of the progress of the task object by updating the task progress status of the task object based on task object-related responses exchanged between the task assigner and the task assignee. Wherein, the task object-related responses correspond to responses related to the task object that can be sent by a user terminal 120 associated with the task assigner or task assignee. In an exemplary embodiment, the task object-related responses may include at least one among a task check response, a task completion response, and a task evaluation response, depending on the current status of the task object.

For example, if the task object manager 370 receives a task interaction from a user corresponding to the task assignee about a “New” task object, it may update the task progress status to the subsequent progress status “Doing”.

In an exemplary embodiment, the task object manager 370 may receive task-related responses from a user terminal 120 associated with the task assigner or task assignee through a control interface about a task object in a shared folder agent, and upon receiving a task object-related response, may determine the current task status and update the corresponding messaging thread.

The task object manager 370 may keep up with the progress of the task object and then eventually receive an evaluation for the task object from the task assigner and give the task object a task evaluation.

The task object manager 370 may provide a reminder message related to the task object to a user terminal 120 associated with the task assignee or task assigner to request completion of the task in progress according to specific criteria for repetition until the task in progress is brought to completion. In an exemplary embodiment, the specific criteria for repetition may be determined for each task progress status based on the deadline or task importance specified by the task assigner.

The file badge manager 330 or task object manager 370 may create a file badge indicating the number of updates the user has not checked, based on a file modification history on a task object or a file object associated with the task object.

The file badge manager 330 or task object manager 370 may provide a user terminal 120 with the corresponding user's file badges for file objects associated with a task object so that the user terminal 120 shows the file badges for the file objects associated with the task object among the file objects in the corresponding folder in the process of showing a file list in the corresponding folder and a task object list. The file badge manager 330 or task object manager 370 may detect the corresponding user's access to file objects and update the user's last access date and time and update the corresponding user's file badges in the corresponding file modification history.

The file badge manager 330 or task object manager 370 may detect a user associated with a file badge whose value exceeds a reference badge value, among all the file badges for each user for file objects, notify of an update to the specific file object each time the user logs in, and provide an access link to the specific file object to suggest to check the update via the access link. In an exemplary embodiment, upon detecting a file badge whose value exceeds a preset reference badge value (e.g., 10), the file badge manager 330 or task object manager 370 may provide a read suggestion message to the user terminal 120 of the detected user to suggest to read the specific file, along with the names of other users who modified the specific file after the detected user's last access date and time, the corresponding file badge, and an access path for accessing the corresponding file object.

In an exemplary embodiment, the file badge manager 330 or task object manager 370 may determine the reference badge value according to the following Equation 1, wherein s denotes the reference badge value, h is a natural number from 1 to 5 which indicates the corresponding folder's level index and may be preset for each folder by the designer or user based on the corresponding folder structure because the higher h, the higher the level of the folder, s₀ is a natural number which indicates an initial value that can be set by the designer or user, uₙ denotes the number of users who can access the associated file object, and round( ) denotes a round-off function by which an internal value is rounded off to the nearest natural number.

$$s = round ( \frac{{s}_{0} {u}_{n}}{h} ) \qquad [ Equation 1 ]$$

The folder chat room manager 380 may provide a folder chat room in the process of providing a file list and file badges for each user for each file. Wherein, the folder chat room is a chat room associated with a folder, and supports messenger chats between users about the folder. Accordingly, the users may enter a messaging thread for chatting in the folder chat room and check messaging threads entered by other users.

At least one folder user may share the folder chat room and participate in the folder chat room. The folder chat room may be created in association with a specific file in the folder, and may include an associated link to a specific file in the folder.

In an exemplary embodiment of the present invention, the folder chat room is also a type of file, which may be included in the file list or displayed separately from the file list. Also, since the folder chat room is also a type of folder, information on modifications or updates to the folder chat room may be provided to the user terminal 120 through the file badges for the folder chat room. It should be noted that the file badges for the folder chat room may be also called folder chat room badges for better explanation and understanding.

Moreover, the folder chat room manager 380 may verify the user terminal 120's access to a folder chat room associated with the folder and provide the folder chat room only when the user terminal 120's access is verified. That is, once the user terminal's access is verified, the folder chat room manager 380 provides a chat room and a messaging thread corresponding to the chat room so that the chat room is materialized into a chat room associated with the folder and part of or an entire messaging thread entered by the user terminal are displayed on the user terminal. More specifically, the folder chat room may be created, deleted, or read by at least one folder user having access to the folder, and messaging threads may be added to the chat room.

The folder chat room manager 380 may create a folder chat room when a folder is created, and may determine participators in the folder chat room by selecting and specifying users by the folder creator. Wherein, each of the at least one participator in the folder chat room may correspond to one of the users of the folder.

The folder notepad manager 380 may select folder chat rooms the user is given access to by verifying the user terminal 120's access, and may provide the user terminal 120 with information about the selected folder chat rooms and a list of folder chat rooms including access paths to the folder chat rooms.

The folder chat room manager 380 may detect updates to the folder chat room and reflect them in a chat room modification history. Wherein, adding a messaging thread to the folder chat room by other users' message input into the folder chat room may be recognized as an update to the folder chat room.

Moreover, the folder chat room manager 380 may create and update a file badge for the folder chat room, i.e., a folder chat room badge, based on the chat room modification history, the user identification information, and the information on the date and time the user accessed the folder chat room.

In addition, if a chat room is created in association with a specific file in a folder, the created folder chat room is reflected in the file modification history for the file. Also, the folder chat room manager 380 may update the file badge for the file along with the creation of the chat room.

The controller 390 may control the overall operation of the processor 210, and may control data flow among the folder access manager 310, file list provider 320, file badge manager 330, folder notepad manager 340, folder manager 350, file update notifier 360, and task object manager 370.

The controller 390 may transmit data or signals among the folder access manager 310, file list provider 320, file badge manager 330, folder notepad manager 340, folder manager 350, file update notifier 360, and task object manager 370 in order to allow the file badge manager 330 to calculate a file badge value, and may control their operations by activating or deactivating these components.

If a folder notepad is specified as a root folder notepad, the controller 390 may set the folder notepad as a basic folder notepad for a corresponding folder and corresponding sub-folders thereof, until a sub-folder notepad is specified as another root folder notepad.

For example, assuming that a first folder has first to third sub-folders as its sub-folders and each sub-folder has one associated folder notepad, the controller 390 may set a folder notepad for the first folder as a root folder notepad for the first to third sub-folders, upon receiving a request from the creator of the first folder to set the folder notepad for the first folder as a root folder note.

Accordingly, upon receiving an access to the second sub-folder from the user terminal 120, the controller 390 may provide a folder notepad associated with the first folder, instead of a folder notepad associated with the second sub-folder, and visualize the folder notepad associated with the first folder and set as a root folder notepad and its corresponding shared notes and visualize other folder notepads in a folder notepad list, in the process in which the user terminal 120 visualizes a list of files in the second sub-folder.

In an exemplary embodiment of the present invention, upon receiving a request to set a folder notepad associated with a specific folder as a root folder notepad, the controller 390 may check whether that folder corresponds to a next-highest level folder or sub-folders in the next-highest level folder, and if so, approve the setting request.

The controller 390 may detect statistical information about files associated with the corresponding folder and all sub-folders in the corresponding substructure, folder notepads, and task objects created through the folder notepads and reflect it on cumulative statistical counts in the corresponding folder.

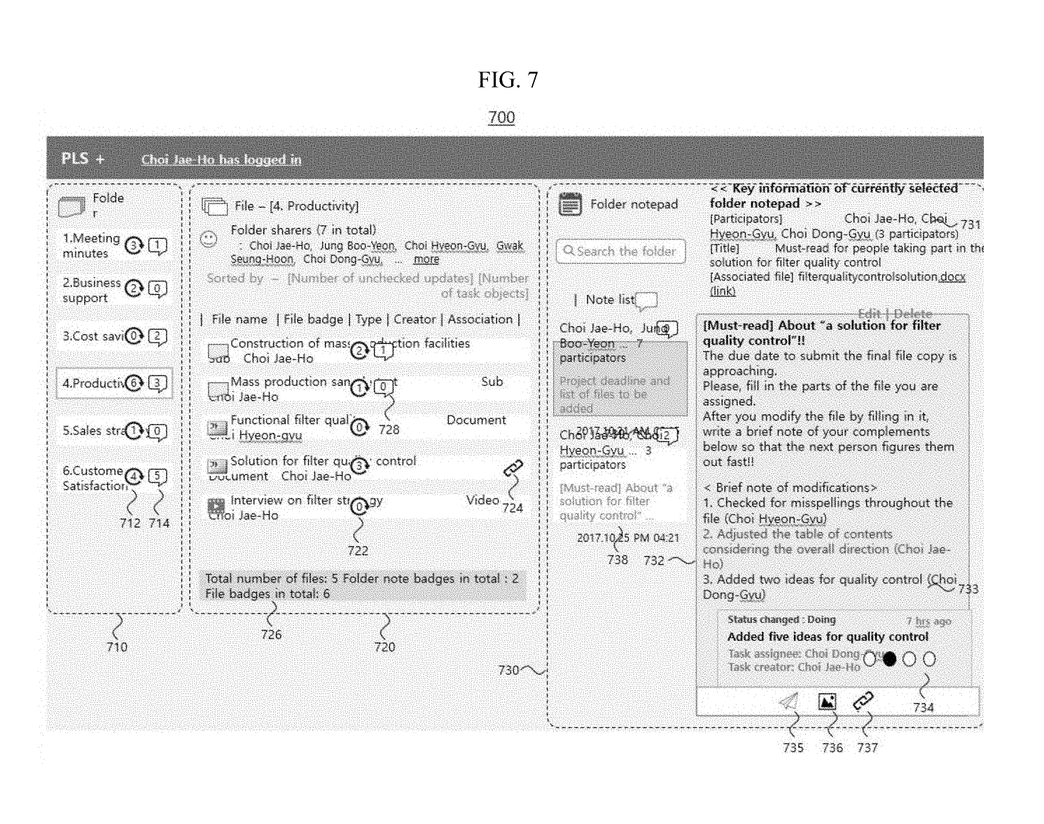

The controller 390 may perform a statistical operation in the process of providing a file list, based on at least one of the following: the total number of folder notepads created in the corresponding folder and its sub-folders, the number of task objects created through the folder notepads, the number of processes, task assigners, and task assignees, and reflect the results on cumulative statistical counts in the corresponding folder. For example, the user terminal 120 may show the cumulative statistical counts in the corresponding folder through a cumulative statistical count symbol (726 of FIG. 7).

The controller 390 may detect task objects that meet reminder requirements determined by their task progress status and deadline at specific time intervals, among all task objects created through folder notepads associated with a folder and all sub-folders in the corresponding substructure and reflect them in a list of today's tasks in that folder, and may provide the user terminal 120 with lists of today's tasks detected from all folders and their corresponding sub-folders so that the user terminal 120 visualize a list of reminder task objects.

The controller 390 may perform filtering on the folders or arrange the folders based on statistical information about unchecked file updates or statistical information about task objects, according to a request from the user terminal 120. For example, the controller 390 may arrange the folders in order of highest number of unchecked file updates in each folder or in order of highest number of created task objects, according to a request from the user terminal 120. In an exemplary embodiment, the controller 390 may provide a folder notepad search function for searching for a specific notepad in the folder, among the folder notepads in the folder and its substructure, according to a request from the user terminal 120.

The controller 390 may perform filtering on the folders or arrange the folders based on statistical information about unchecked file updates or unchecked associated file updates, according to a request from the user terminal 120. For example, the controller 390 may arrange the folders in order of highest number of unchecked folder notepad updates in each folder (in order of highest number of folder note badges), according to a request from the user terminal 120. The controller 390 may provide a folder notepad search function for searching for a specific notepad in the folder, among the folder notepads in the folder and its substructure, according to a request from the user terminal 120.

Moreover, the controller 390 may accumulate statistical information about task objects associated with at least one file object in a folder and its sub-folders and reflect it on the statistical count of task objects in that folder. In an exemplary embodiment, the controller 390 may detect statistical information about task objects associated with file objects in that folder and include it in cumulative statistical counts. For example, the controller 390 may perform a statistical operation based on at least one of the following: the number of task objects created, the number of processes, and the associated task assigners and task assignees and reflect the results on cumulative statistical counts in the corresponding folder.

When the user of the user terminal 120 accesses a folder, the controller 390 may add the values of file badges for a user for at least some file objects associated with task objects, among all file objects in that folder or its sub-folders and provide the sum as the cumulative count of file badges indicating the number of file updates to the entire folder the user has not checked.

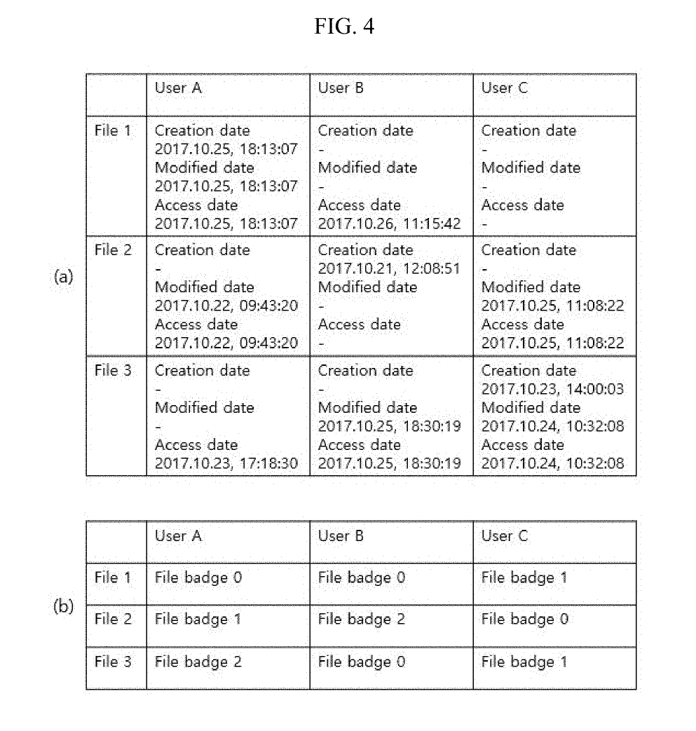

FIG. 4 is a view showing an exemplary embodiment of a process in which the file badge manager 330 in FIG. 3 manages file updates in a sequential list that is chronologically vectorized.

In an exemplary embodiment, the file badge manager 330 may manage time stamps as a time-varying parameter for each of at least one file in a folder on a per-user and per-file basis and reflect them on file badges for each user for each file. Wherein, a time stamp may include the creation date and time, the last modified date and time, and the last access date and time.

For example, as shown in (a) of FIG. 4, the file badge manager 330 may create file badges for each user for each file, which are defined by time stamps for each user for each file, and may update the file badges for each user for each file whenever each user accesses or modifies each file.

Moreover, as shown in (b) of FIG. 4, the file badge manager 330 may calculate and update the values of the file badges for each user for each file based on real-time updates to the file badges for each user for each file. If the user of the user terminal 120 requesting access to the folder is User A, File Badges 0, 1, and 2 for Files 1, 2, and 3 in the folder may be provided to the user terminal 120.

In another exemplary embodiment, an exemplary embodiment of a process in which the file badge manager 330 or folder notepad manager 340 in FIG. 3 manages file badges for a user' folder notes (hereinafter, referred to as folder note badges for convenience) will be described with reference to FIG. 4.

In FIG. 4, the file badge manager 330 or folder notepad manager 340 may acquire user information associated with the user terminal 120 and create the user's folder note badges based on the user's last access date and time in the folder note modification history and the note content modified after that last access date and time.

In an exemplary embodiment, the file badge manager 330 or folder notepad manager 340 may manage each user's own folder note modification history for each folder notepad. In another exemplary embodiment, the file badge manager 330 or folder notepad manager 340 may manage each user's own folder note modification history for each of at least one folder notepads in the folder.

The file badge manager 330 or folder notepad manager 340 may manage time stamps as a time-varying parameter for a folder notepad on a per-user basis and reflect them on file badges for each user. Wherein, a time stamp may include the creation date and time, the last modified date and time, and the last access date and time.

In an exemplary embodiment, the file badge manager 330 or folder notepad manager 340 may check the times note participators accessed the folder notepad in real time and store and manage time stamps for each user for the folder notepad in the folder note modification history, as shown in (a) of FIG. 4, and may create file badges for each user for the folder notepad based on the last updated time stamps for each user, as shown in (b) of FIG. 4.

For example, in FIG. 4, once access to Folder Notepad 1 from the user terminal 120 associated with User A is verified, the folder notepad manager 340 may detect the creation date and time 2017.10.21 12:08:51 and the modification dates and times 2017.10.22 09:43:20 and 2017.10.25 11:08:22 from the folder note modification history for Folder Notepad 1, and may detect User A's last access date and time 2017.10.22 09:43:20, count the number of modifications made after that access date and time as 1, and calculate the file badge of User A as 1. This means that one modification was made to the folder notepad by another user after User A last opened the folder notepad.

Moreover, referring to FIG. 4, an exemplary embodiment of a process in which the file badge manager 330 or task object manager 370 in FIG. 3 manages users' file badges for a task object or a file object associated with the task object.

In FIG. 4, the file badge manager 330 or task object manager 370 may create file badges for each user indicating the number of updates not checked by each user that are made to a task object or a specific file object associated with the task object, based on each user's own file modification history for the specific file object associated with the task object and each user's file access times.

More specifically, the task object manager 370 may detect the user terminal 120's access to a task object or a specific file object associated with the task object and update the user's last access date and time and the user's file badge in the file modification history.

In an exemplary embodiment, the task object manager 370 may manage time stamps as a time-varying parameter for a task object or a specific file object associated with the task object on a per-user basis and reflect them on file badges for each user. Wherein, a time stamp may include the creation date and time, the last modified date and time, and the last access date and time.

In an exemplary embodiment, the task object manager 370 may check the times each user accessed a task object or a file object associated with it in real time and update time stamps for each user in the file modification history, as shown in (a) of FIG. 4, and may create file badges for each user for the task object or the file object associated with it based on the last updated time stamps for each user, as shown in (b) of FIG. 4.

Once access to File 1 from the terminal 120 is verified, the creation date and time 2017.10.21 12:08:51 and the modification dates and times 2017.10.22 09:43:20 and 2017.10.25 11:08:22 may be detected from the file modification history for File 1, and User A's last access date and time 2017.10.22 09:43:20 may be detected, the number of modifications made after that access date and time may be counted as 1, and the file badge of User A may be calculated as 1. This means that one modification was made to the file object by another user after User A last opened the file object.

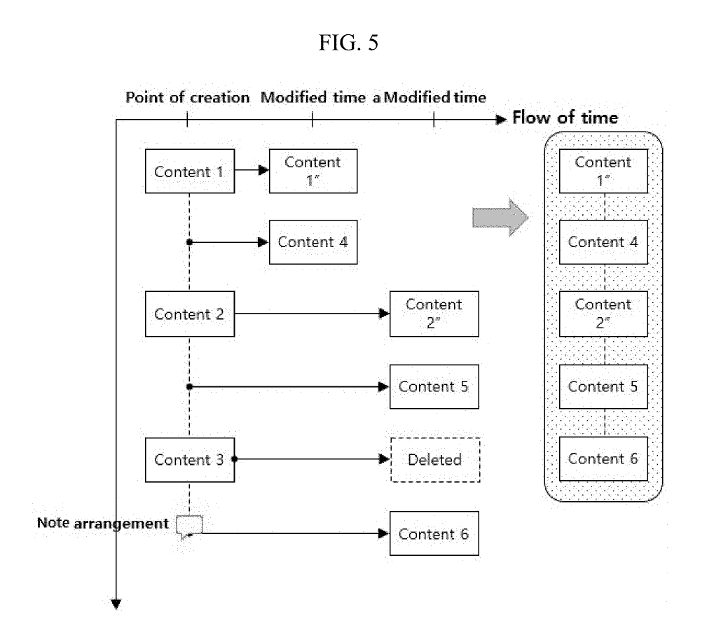

FIG. 5 is a view showing an exemplary embodiment of a process in which the processor 210 manages modified files in a sequential list that is chronologically vectorized.

In FIG. 5, the processor 210 may detect updates made to a file by a certain user terminal 120, such as modifications, changes, etc. and manage it in a sequential list that is chronologically vectorized based on the creation dates and times and the modified dates and times. Wherein, the file may include a folder notepad, a task object, a file associated with a task object, etc., as explained previously, as well as a general file object.

In an exemplary embodiment, when a file is created, the processor 210 may vectorize a plurality of content items making up the file in a sequential file arrangement. Also, each time a content item is added, modified, or deleted as time flows from the point of file creation, the processor 210 may manage the content item by connecting it to at least some of the existing content using a vector.

For example, if the created file includes a sequence of Content 1, Content 2, and Content 3, the processor 210 may manage these content items in a sequential vectorized list of Content 1, Content 2, and Content 3. Also, if Content 1 is modified to Content 1″ by a folder user at the modification date and time a and Content 4 is added between Content 1 and Content 2 using a vector, Content 1 may be connected to Content 1″ using a vector, and a point between Content 1 and Content 2 may be connected to Content 4 using a vector.

The processor 210 may detect that a file is read by the user terminal 120 and keep track of modified content in that file after the date and time the user last accessed the file.

More specifically, upon sensing or detecting that one of the folder users has attempted to read a file, the processor 210 may check the date and time the user last accessed the file, analyze files managed in a sequential list that is chronologically vectorized, and detect content that has been modified after the access date and time.

For example, if it is ascertained that the date and time the user last accessed the file are between the modification date and time a and the modification date and time b, the processor 210 may detect Content 2″ (modified), Content 5 (added), Content 3 (deleted), and Content 6 (added) as the content in the file recently modified by the user.

Moreover, the processor 210 may provide the user terminal 120 with modified content in a file, which is tracked in the process of providing a file or file list, so that the user terminal 120 may open and display the modified portion of the file in a specific color, font, or size different from the unmodified portion.

For example, when the user terminal 120 opens the file and displays it, the processor 210 display the portions corresponding to Content 2″ (modified), Content 5 (added), Content 3 (deleted), and Content 6 (added) in red, which are tracked as the recently modified content in the file. Thus, the user is able to visually and intuitively perceive the recently modified portion of the entire file from the user's point of view, thereby allowing for easier checking of the modified content.

FIG. 6 is a flowchart showing a folder-based file management method according to an exemplary embodiment of the present invention.

A folder-based file management device according to an exemplary embodiment of the present invention includes a memory and a processor electrically connected to the memory.

Wherein, the folder access manager 310 of the processor 210 may first sense a user terminal's access to a folder or receive a signal for the access (S610). In this process, it can be verified first whether the user terminal has access to the folder or not. Wherein, user terminal information, user identification information of the user of the user terminal, etc. may be used. That is, the folder access manager 310 may receive or acquire user identification information of the user of the user terminal from the user terminal and verify whether the user terminal has access to the folder.

The file list provider 320 may provide a list of files in a folder in accordance with the authority of a user terminal that accesses the folder (S620). The file list provider 320 may make and provide a file list consisting only of files in a folder which the user terminal is given access to, among all files located in the folder and accessible by the folder. User identification information or information on the user terminal may be used as well in the process of picking out files the user has access to.

In an example, if a user is designated as a shared user of the folder, a folder user, or a task sharer, the user may be given access to the folder. Also, access to each file may be preset. That is, users who share the same folder may be given access to different files.

The file badge manager 330 may keep track of a user's access history for each file accessible by the user and calculate the user's unique file badge value for each file. Then, the file list provider 320 and the file badge manager 330 may provide file badges for files the user terminal is given access to, along with a file list. The file badges may be displayed along with each file item in the folder.

Wherein, the file badges may be symbols indicating the number of file updates not read by the user terminal that are made when a file the user terminal is given access to is uploaded or updated. Also, the number of file updates made to a specific file but have not yet been read by the user terminal may be a filed badge value shown on the file badge for that file.

The file badge manager 330 may detect file updates, including modifications, changes, and note additions to the file and update a per-file file modification history for the file for each user on a per-user basis, based on the updates to the file. Also, the file badge manager 330 may create file badges for each file for the user, based on the per-file file modification history, the user identification information, and the user terminal' file access times.

Wherein, the file may be a folder notepad associated with the folder. Wherein, the folder notepad may be a notepad that can be materialized into a notepad associated with the folder on the user terminal when the user terminal's access is verified and includes folder notes that can be modified and kept track of.

In this case, too, the file badge manager 330 may detect updates to the folder notes and reflect them in a folder note modification history. Also, the file badge manager 330 may create file badges, that is, folder note badges, for the folder notepad, based on the folder note modification history, the user identification information, and information about the date and time the user terminal accessed the folder notepad, and may keep them updated.

Moreover, a task object or a file associated the task object may be also a type of file in an exemplary embodiment of the present invention. Wherein, the task object may be accessed through a folder, and may be capsulized, including information about one or more of the following: a task assigner, a task assignee, task assignment details, performed task details and task processing details. Either or both of the task assignee and the task assigner may give feedback about the task object.

In this case, if a task object is created in association with the file, the file badge manager 330 may reflect the created task object in the file modification history for the file and update the file badge for the file or task object based on the result.

That is, if a task object is associated with a specific file, it means that a task object associated with that file is created, and the file badge value of that file may increase by 1. Likewise, if n updates are made to an associated task object, the n updates are reflected on the file badge for the file with which the task object is associated, and the file badge value of that file may increase by n.

Accordingly, the file badge manager 330 may detect updates to the task object and reflect them in a task object modification history, may create a file badge for the task object or the file associated the task object based on the task object modification history with the updates reflected in it, the user identification information, and the information about the date and time the user terminal last accessed the task object, and may keep them updated.

Afterwards, the file badge manager 330 may provide file badges for each file, along with a file list, based on calculated file badge values (S630). Then, the file badges may be provided and displayed on the user terminal along with the file list.

Moreover, the file badge manager 330 may receive, from the folder access manager 310, information about whether a user terminal has accessed a file or not and information about the date and time the user last accessed each file and update the date and time the user terminal last accessed each file on a per-user basis. Then, the file badge manager 330 may update file badges for each user for each file by repeatedly and regularly collecting updates on the last access date and time.

In addition, the file badge manager 330 may provide the user terminal with updates to the file. Then, when the user terminal opens a final modified version of the file and presents it through an output unit of the user terminal 120, it may display the updated portion in one or more of a specific color, font, and size, different from the rest. That is, if there is modified content in the file, the user terminal 120 displays the modified content in a way visually distinct from the unmodified portion, thereby providing convenience to the user.

If there is one or more files in the folder, the file badge manager 330 or controller 390 may calculate the folder badge value of the folder by cumulatively adding up the file badge values of the files. Then, the file badge manager 330 or controller 390 may create a folder badge for the folder by using the calculated folder badge value. In this case, the folder badge value of the folder equals the sum of the file badge values of the files in the folder.

FIG. 7 is a view showing an exemplary embodiment of a process in which a user terminal in FIG. 1 provides a shared folder interface by working in conjunction with a folder-based file management device.

For example, as shown in FIG. 7, the file badge manager 330 display file badges [0], [3], and [0] for files “Functional filter quality”, “A solution for filter quality control”, and “Interview on filter strategy” through the file list's first file badge symbols 722, based on file badges for each user for each file in the corresponding folder of a user “Choi Jae-Ho” in the process in which the user terminal 120 visualizes the file list in the [4. Productivity] folder. Among these file badges, the file badge [3] of “A solution for filter quality control” indicates that a total of three modifications were made by other users after the user “Choi Jae-Ho” last opened or downloaded the file.

In FIG. 7, the user terminal 120 may display general information about a folder via a shared folder interface 700 for a shared folder agent installed on the user terminal 120, based on general information about the folder and files in it received from the folder-based file management device 110, and may request the folder-based file management device 110 for access or creation, file management, and folder notepad creation through a shared folder interface 700 upon a user request.

The user terminal 120 may access the shared folder agent and request the folder-based file management device 110 for access to a shared folder, and may receive a list of accessible folders from the folder-based file management device 110 and visualize it through a folder window 710 of the shared folder interface 700. The user terminal 120 may visualize file badge cumulative counts which are calculated for each folder and received from the folder-based file management device 110.

In an exemplary embodiment, the user terminal 120 may show the file badge cumulative account for general files through the folder list's first file badge cumulative count symbols 712 and the file badge cumulative account for the folder notepad through the folder list's second file badge cumulative count symbols 714, among the file badge cumulative counts which are calculated for each folder and received from the folder-based file management device 110.

For example, in the case of the currently selected [4. Productivity] folder in FIG. 7, the file badge cumulative count for general files in the folder is 6, and the file badge cumulative count for the folder notepad is 3.

Referring to FIG. 7, the file badge cumulative count [6] calculated by accumulating created file badges for each file in the entire [4. Productivity] folder and the file badge cumulative count [2] calculated by accumulating created file badges for each file in the entire [Construction of mass production facilities] sub-folder may be displayed through the folder list's first file badge cumulative count symbol 712 and the file list's first file badge cumulative count symbol 722, respectively.

Also, the folder manager 350 may display association information of a file through an association indicator symbol 724 in the process of providing a file list containing association information of each file and visualizing the file list by the user terminal 120.

The user terminal 120 may attempt to access a specific folder in the folder list as the user selects, and, when given access to the folder, may be provided with a file window 720 and folder notepad window 730 of the shared folder interface 700 in association with the specific folder, in order to receive a list of files in the folder, file badges for each user for each file, and a folder notepad and materialize them.

Upon receiving a list of files in the folder from the folder-based file management device 110, the user terminal 120 may visualize metadata about the files and sub-folders of the folder through the file window 720. The user terminal 120 may visualize the file badges for each file received from the folder-based file management device 110.

In an exemplary embodiment, the user terminal 120 may display file badge cumulative counts for general files in an entire sub-folder of a folder through the file list's first file badge cumulative count symbols 722 in the file window 720. For a general file, the file badge for the user (Choi Jae-Ho) of the file may be displayed to indicate the number of updates to the general file.

The user terminal 120 may display the file badge cumulative count for files in each entire sub-folder of the folder and the file badge cumulative count for the folder notepad through the file list's second file badge cumulative count symbols 728.

The user terminal 120 may visualize whether a file is associated with the folder notepad for the folder by displaying association information of each file through a association indicator symbol 724, and may visualize the total number of files (total number of files: 5) in the folder and its sub-structure, the sum of the file badge values of all those files (sum of file badge values: 6), and the sum of all folder note badge values (sum of folder note badge values: 2) in the sub-structure by displaying cumulative statistical counts for the folder through a cumulative statistical count symbol 726.

Upon receiving a specific user input (e.g., the user's touch on an empty space, a right-mouse click, etc.) through the folder window 710 or file window 720, the user terminal 120 may additionally provide a folder control interface (not shown) and receive a user request for at least one of the following: creating a new folder, a new sub-folder in that folder, or a new folder notepad through the folder control interface, transmission and reception (file upload or file download) of a new file, setting up an association between a specific file and the folder notepad, eliminating a setup association, moving the folder notepad or a file object to other folders, inviting a folder user, and designating a folder notepad participator.

The user terminal 120 may receive a folder notepad from the folder-based file management device 110 and visualize it through a folder notepad window 730. The user terminal 120 may request to view the shared notes in the folder notepad and modify the content based on user interaction through the folder notepad window 730.

The user terminal 120 may show who are participating in the folder notepad, the title of the folder notepad, and an associated link file through a folder notepad key information indicator column 731.

The user terminal 120 may display the shared notes in the folder notepad through a shared note indicator column 732. The user terminal 120 may receive note content the user has not checked in the shared notepad from the folder-based file management device 110, and display it in a specific color, as in Identification Number 733. If two different users made modifications after the date and time the user “Choi Jae-Ho” last accessed the shared notepad, the user terminal 120 may display the first modified content in a first color (red) and the second modified content in a second color (blue), as in Identification Number 733.

If a task object is added to the folder notepad, the user terminal 120 may present the task object as an independent object, distinct from general text notes created in the folder notepad, and may visualize the task details, task assigner, task assignee, and task progress status of the task object (regarding the task progress status, the current task status may be indicated by symbols corresponding to the current phases of work such as New (●◯◯◯), Doing (◯●◯◯), Done (◯◯●◯), or Checked (◯◯◯●)).

The user terminal 120 may send a task to the folder-based file management device 110, including a task assigner, task assignee, task details, and task evaluation specified by the user through a task object creation button 735. Accordingly, the folder-based file management device 110 may create a task object including the task, add it as a new task object to the corresponding folder notepad, and visualize the new task object in the folder notepad in a way similar to Identification Number 734.

The user terminal 120 may include a file in the folder notepad through a file upload button 736, and may establish an association between the folder notepad and a specific file in the folder through an association setup button 737 and create an associated link in the folder notepad.

The user terminal 120 may visualize a folder notepad list received from the folder-based file management device 110 through a folder notepad list indicator column 738. This way, when another folder notepad is selected by the user, the user may request the folder-based file management device 110 to open the selected folder notepad and receive at least some of requested messaging threads from the folder-based file management device 110 and visualize the newly received folder notepad instead of the existing folder notepad.

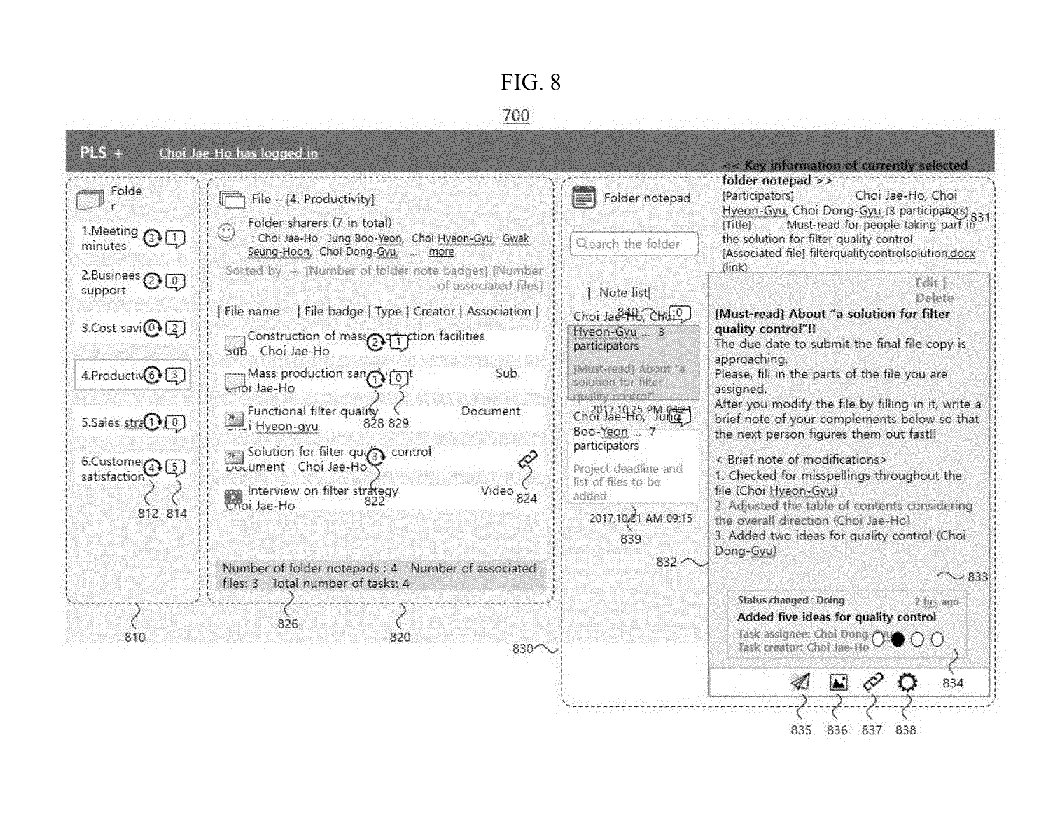

FIG. 8 is a view showing another exemplary embodiment of a process in which a user terminal provides a user interface by working in conjunction with a folder-based file management device.

In FIG. 8, the user terminal 120 may display information about a folder, its files, and its folder notepad via a shared folder interface 800 for a shared folder agent installed on the user terminal 120, based on folder information, a file list, and the folder notepad which are provided from the folder-based file management device 110, and may receive a user input including a folder access request, file access request, and folder notepad access request through the shared folder interface 800 and send it to the folder-based file management device 110.

The user terminal 120 may access the shared folder agent and request the folder-based file management device 110 for access to a folder associated with the user, and may receive a list of accessible folders from the folder-based file management device 110 and visualize it through a folder window 810.

The user terminal 120 may receive associated file badge cumulative counts, which are calculated for each folder, from the folder-based file management device 110 and display them through first associated file badge cumulative count symbols 812, and may receive folder note badge cumulative counts, which are calculated for each folder, from the folder-based file management device 110 and display them through first folder note badge cumulative count symbols 814.

The user terminal 120 may attempt to access a specific folder in the folder list as the user selects, and, when given access to the folder by verifying the user terminal 120's authority to access, may be provided with a file window 820 and folder notepad window 830 in association with the specific folder, in order to receive a list of files in the folder, a folder notepad, and a folder notepad list from the folder-based file management device 110 and materialize them.

Upon receiving a list of files in the folder from the folder-based file management device 110, the user terminal 120 may visualize metadata about the files in the file list and the sub-folders through the file window 820.

The user terminal 120 may display the user's file badge for each file in the folder associated with the folder notepad, through an associated file badge symbol 822 of the file window 820, visualize through an association indicator symbol 824 whether a file is associated with the folder notepad and provide an access link for accessing the associated folder notepad, and may visualize the total number of folder notepads (total number of folder notepads: 4) in the folder and its sub-structure, the number of files (number of associated files: 3) for which associated links to all the folder notepads are created, and the total number of task objects (total number of tasks: 4) created through all the folder notepads by displaying cumulative statistical counts for the folder through a cumulative statistical count symbol 826.

The user terminal 120 may receive associated file badge cumulative counts, which are calculated for each sub-folder, and display them through second associated file badge cumulative count symbols 828, and may receive folder note badge cumulative counts, which are calculated for each sub-folder, and display them through second folder note badge cumulative count symbols 829.

The user terminal 120 may visualize a folder notepad list received from the folder-based file management device 110 through a folder notepad list indicator column 839. This way, upon receiving the user's input for selecting another folder notepad, the user may request the folder-based file management device 110 to open the selected folder notepad and visualize the received folder notepad. The user terminal 120 may receive the user's folder note badge, which is calculated for each folder notepad, from the folder-based file management device 110 and display it through a folder note badge symbol 840. When the user's folder note badge for the corresponding folder notepad is updated after the folder notepad is open, the update may be reflected to update the folder note badge symbol 840.

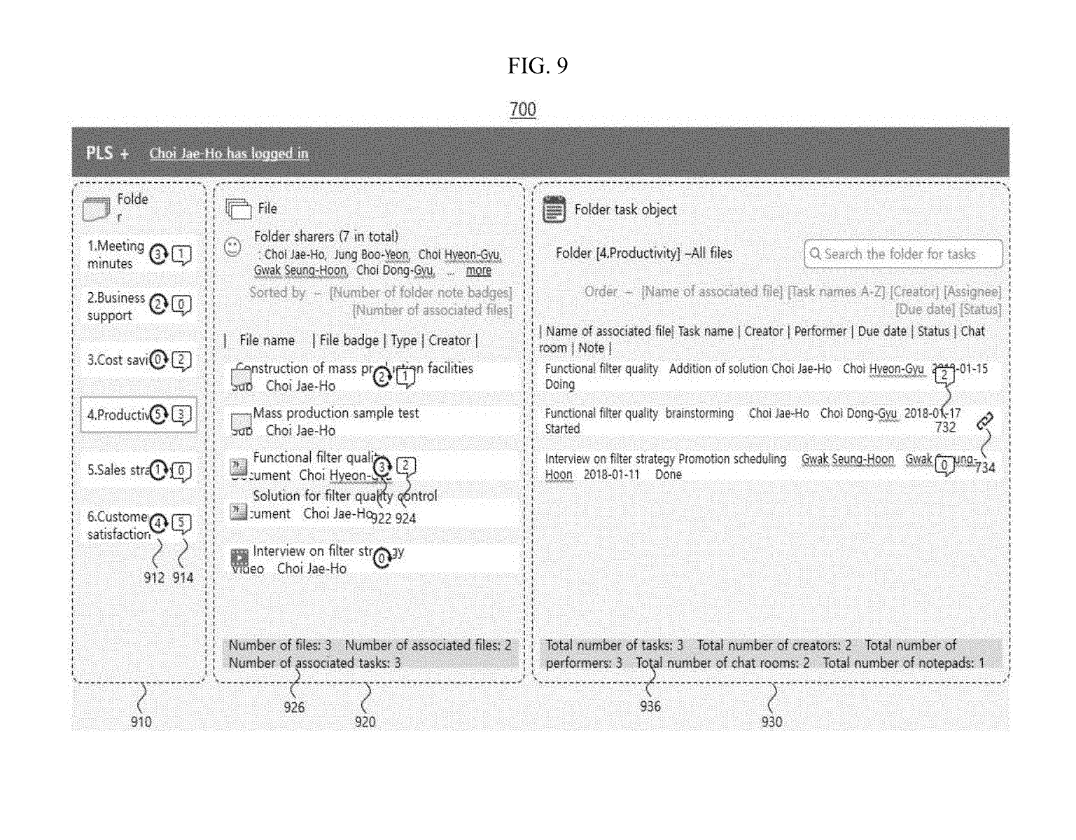

FIG. 9 is a view showing yet another exemplary embodiment of a process in which a user terminal provides a user interface by working in conjunction with a folder-based file management device.

In FIG. 9, the user terminal 120 may display information about a folder, its file objects, and its associated task objects via a shared folder interface 900 for a shared folder agent installed on the user terminal 120, based on folder information, a file list, and a task object list which are provided from the folder-based file management device 110, and may receive a user input including a folder access request, file object request, and associated task object access request through the shared folder interface 900 and send it to the folder-based file management device 110.

The user terminal 120 may access the shared folder agent and request the folder-based file management device 110 for access to a folder associated with the user, and may receive a list of accessible folders from the folder-based file management device 110 and visualize it through a folder window 910. The user terminal 120 may visualize file badge cumulative counts which are calculated for each folder and received from the folder-based file management device 110.

The user terminal 120 may receive associated file badge cumulative counts, which are calculated for each folder, from the folder-based file management device 110 and display the total number of updates to file objects in the folder associated with the task objects the user has not checked through file badge cumulative count symbols 912 and display the number of updates to associated messaging threads, which is accumulated for each folder, through a task chat room new message cumulative count symbol 914

The user terminal 120 may attempt to access a specific folder in the folder list as the user selects, and, when given access to the folder by verifying the user terminal 120's authority to access, may be provided with a file window 920 and folder notepad window 930 in association with the specific folder, in order to receive a list of files in the folder and a task object list from the folder-based file management device 110 and materialize them.

Upon receiving a list of files in the folder from the folder-based file management device 110, the user terminal 120 may visualize key information about the files in the file list and the sub-folders through the file window 920.

The user terminal 120 may display the user's file badge for each file object in the folder associated with the task objects, through an associated file badge symbol 922 of the file lit window 920, display the number of new messages the user has not checked that are created in task chat rooms associated with task objects associated with each file object through first task chat room new message count symbols 924, and visualize the total number (number of files: 3) of file objects in the folder, the number (number of associated files: 2) of file objects associated with the task objects, and the number (number of associated tasks: 3) of task objects associated with the file objects by displaying cumulative statistical counts for the folder through a first cumulative statistical count indicator column 926.

The user terminal 120 may receive a task object list from the folder-based file management device 110 and visualize it through a task object window 930. The user terminal 120 may display key information about all task objects associated with the file objects in the folder through the task object window 930. As shown in FIG. 9, the user terminal 120 may receive and visualize a task object list, including the names of file objects associated with each task object, the names of tasks for the task objects, task creators, task assignees, task deadlines, task statuses, the presence or absence of an associated task chat room(s) (if any, an access link(s) is provided), and the presence or absence of an associated task notepad (if any, an access link(s) is provided).

The user terminal 120 may display the number of new messages the user has not checked that are created in task chat rooms associated with task objects in the task object list through second task chat room new message count symbols 932. If there is a task notepad associated with a task object in the task object list, information on the presence or absence of the task notepad and an access path for accessing the task notepad may be provided through a task notepad link symbol 934. Also, statistical information about the number of created associated task objects, the number of task creators, the number of task assignees, the number of associated task chat rooms, and the number of associated task notepads may be displayed by displaying cumulative statistical counts for the task objects in the task object list through a second cumulative statistical count indicator column 936.

If a specific task object in the task object list is selected by the user, the user terminal 120 may request the folder-based file management device 110 for access to the selected task object, and may receive and visualize detailed information on the selected task object from the folder-based file management device 110. In an exemplary embodiment, the user terminal 120 may receive an access link to a task chat room or task notepad associated with the selected task object or task notes of the associated task notepad and visualize them in the process of visualize the detailed information on the selected task object.

The disclosed technology has the following advantages. However, since it does not mean that a specific embodiment should have all the advantages or should have only the advantages, it should not be understood that the range of the rights of the disclosed technology are limited by the advantages.

A folder-based file management device and method according to an exemplary embodiment of the present invention may let the user intuitively know about file updates by other users by managing files in a shared folder using the concept of a file badge per user per file and a folder badge per user per folder.

A folder-based file management device and method according to an exemplary embodiment of the present invention may provide real-time update information to users and offer convenience in folder and file management tailored to each individual user by notifying other users of a user's file modification and change events and adding or subtracting file badge values or folder badge values depending on whether each user has checked the events or not.

Although preferred exemplary embodiments of the present invention have been described above, those skilled in the art will understand that the present invention may be variously modified and changed without departing from the spirit and scope of the present invention described in the following claims.

What is claimed is:

1. A folder-based file management device comprising a memory and a processor electrically connected to the memory,
the processor being configured to:
(a) sense a user terminal's access to a folder;
(b) provide a list of files in the folder the user terminal is given access to; and
(c) provide file badges for the files the user terminal is given access to,
wherein the file badges indicate the number of file updates not read by the user terminal that are made when a file the user terminal is given access to is uploaded or updated.

2. The folder-based file management device of claim 1, wherein the processor detects file updates, including modifications, changes, and note additions to the file and updates a per-file file modification history for the file on a per-user basis, based on the updates to the file.

3. The folder-based file management device of claim 2, wherein the processor acquires user identification information of the user of the user terminal and verifies whether the user terminal has access to the folder.

4. The folder-based file management device of claim 3, wherein the processor creates file badges for each file for the user, based on the per-file file modification history, the user identification information, and the user terminal' file access times.

5. The folder-based file management device of claim 4, wherein the processor detects the user's access to the file and update the user's last access time and the file badge for the file for the user.

6. The folder-based file management device of claim 1, wherein the file is a folder notepad associated with the folder, wherein the folder notepad is a notepad that can be materialized into a notepad associated with the folder on the user terminal when the user terminal's access is verified and includes folder notes that can be modified and kept track of.

7. The folder-based file management device of claim 6, wherein the processor detects updates to the folder notes and reflect the updates in a folder note modification history, and creates and updates file badges for the folder notepad, based on the folder note modification history, the user identification information, and information about the date and time the user terminal accessed the folder notepad.

8. The folder-based file management device of claim 6, wherein, if a folder notepad is created in association with the file, the processor reflects the created folder notepad in the file modification history for the file and updates the file badge for the file.

9. The folder-based file management device of claim 1, wherein the file is a folder chat room associated with the folder, and when the user terminal's access is verified, the folder chat room is materialized into a chat room associated with the folder and part of or an entire messaging thread entered by the user terminal are displayed.

10. The folder-based file management device of claim 9, wherein the processor detects updates to the folder chat room and reflects the updates in a chat room modification history, and creates and updates a file badge for the folder chat room, based on the chat room modification history, the user identification information, and the information on the date and time the user terminal accessed the folder chat room,
wherein the updates to the folder chat room include adding the messaging thread.

11. The folder-based file management device of claim 9, wherein, if the folder chat room is created in association with the file, the created folder chat room is reflected in the file modification history for the file, and the file badge for the file is updated.

12. The folder-based file management device of claim 1, wherein the file is a task object which is accessible through the folder, capsulized, including information about one or more of the following: a task assigner, a task assignee, task assignment details, and task processing details, and about which either or both of the task assignee and the task assigner can give feedback.

13. The folder-based file management device of claim 12, wherein, if a task object is created in association with the file, the processor reflects the created task object in the file modification history for the file and updates the file badge for the file.

14. The folder-based file management device of claim 12, wherein the processor detects updates to the task object and reflects the updates in a task object modification history, and creates and updates a file badge for the task object, based on the task object modification history, the user identification information, and the information about the date and time the user terminal accessed the task object.

15. The folder-based file management device of claim 1, wherein the processor calculates the folder badge value of the folder by cumulatively adding up the file badge values of one or more files in the folder, and creates a folder badge for the folder by using the calculated folder badge value.

16. The folder-based file management device of claim 1, wherein, when the processor provides the user terminal with updates to the file and presents a final modified version of the file, the updated portion is displayed in one or more of a specific color, font, and size, different from the rest.

17. A folder-based file management method which is performed by a folder-based file management device comprising a memory and a processor electrically connected to the memory, the method comprising:
(a) sensing a user terminal's access to a folder;
(b) providing a list of files in the folder the user terminal is given access to; and
(c) providing file badges for the files the user terminal is given access to,
wherein the file badges indicate the number of file updates not read by the user terminal that are made when a file the user terminal is given access to is uploaded or updated.

18. A recording medium having a computer program about a computer-executable shared folder file management method recorded thereon, the recording medium comprising the functions of:
(a) sensing a user terminal's access to a folder;
(b) providing a list of files in the folder the user terminal is given access to; and
(c) providing file badges for the files the user terminal is given access to, [symbol]
